(19) United States
(12) Patent Application Publication
(10) Pub. No.: US 2008/0018894 A1
(43) Pub. Date: Jan. 24, 2008

(54) Optical ball lens light scattering apparatus and method for use thereof

(76) Inventors: Jianping (Lily) Zu, East Setauket, NY (US); Walther Tscharnuter, Mount Sinai, NY (US)

Correspondence Address: Panagiota Betty Tufariello, Esq.;INTELLECTULAW, THE LAW OFFICES OF P.B. TUFARIELLO, P.C., 25 Little Harbor Road, Mt. Sinai, NY, 11766, US

(21) Appl. No.: 11/800,666

(22) Filed: May 7, 2007

Related U.S. Application Data
(60) Provisional application No. 60/746,642, filed on May 7, 2006.

(51) Int. Cl. G01N 21/00; G01N 1/10

(52) U.S. Cl. 356/338; 356/246; 356/337

(57) ABSTRACT

The inventive optical spherical lens light scattering apparatus and method for use thereof comprises an incident light source, a spherical or ball optical lens system and a photo detector. The spherical or ball lens optical system comprises at least one ball or spherical lens being in contact with a specimen of fluid dispersed particles; said ball lens having, as a result of its spherical geometry, and as compared to a plano-convex or convex lens, a relatively short focal point. When the incident light source is used to generate a beam of light, and the beam of light is then focused through the spherical or ball lens, it lands at a point that is much closer to the lens, as compared to the point it normally lands on, when it is focused through a plano-convex, or a convex lens. It is the proximity of the spherical or ball lens' focal point to the spherical or ball lens itself, and the contacting of the ball lens to the specimen of fluid-dispersed particles, that minimizes, if not eliminates all light scattering masking of particles' light scattering results. The method of use of the said apparatus comprises the steps of: (i) using the incident light source to generate a beam of energy having a certain wavelength and frequency; (ii) focusing said beam of energy through a ball lens; (iii) placing a specimen of fluid-dispersed particles, in contact with the ball lense and within the focal point of the ball lens so that the focused beam of energy hits the suspended particles at exactly the focal point of the ball lens and the suspended particles scatter the beam of energy; and (iv) directing that scattered light produced by the suspended particles through a ball lens onto a photodetector.

### CLAIM OF PRIORITY

The present non-provisional application hereby claims priority of the earlier filed U.S. Provisional Application No. 60/746,642 by virtue of the fact that the applicants are the inventors of the subject matter for which protection was sought by way of said earlier filed provisional application.

### BACKGROUND OF THE INVENTION

1. Field of Invention

The present invention relates to a method and apparatus for use in light scattering instrumentation. More importantly it relates to a new and improved optical lens system for use in conjunction with light-scattering detectors utilized for, among other things, the determination of molecular and colloidal properties and structure functions for complex fluids, protein characterization, particle sizing, particle size distribution analysis, zeta potential distribution and zeta potential in low mobility suspensions. More particularly, the present invention relates to an optical lens system that can be utilized to integrally form many light scattering systems' components, as for example a sample cell for use with light scattering detectors, and a light scattering detector probe.

2. Description of the Prior Art

Light scattering techniques are analytical science techniques that use certain properties of light to determine, among other things, the size of particles, particle size distributions, and molecular weights. The term “particles” as being used herein, denotes objects whose size can range from macromolecule size at one extreme end of the spectrum, to large mammalian cell or even phytoplankton size at the other end. Macromolecule size in turn, can vary from one nanometer (one billionth (10⁻⁹) of a meter) in length to tens of micrometers; a size that can be determined by using the properties of light.

When particles are suspended, i.e., when they are in suspension, in a fluid or even in air, they actually move in a random pattern. This movement of small particles suspended in a medium or a resting fluid is termed “Brownian Motion.” Observation and comparison of the “Brownian” motion of larger particles to the Brownian motion of smaller particles reveals that the smaller particles move much faster than the larger particles. As a result, small particles diffuse faster and large particles diffuse slower.

Properties of light that can be used to determine particle size are its wavelength and its frequency. Frequency is a measure of how many waves pass through a given point during one second. The more waves cross the point, or the closer the distance between the waves, the higher the frequency. When a beam of light, such as a laser beam, having a known wavelength and frequency, is focused on moving particles, i.e. when a beam of radiant energy is incident upon a particle, a portion of this energy will be scattered in all directions. However, the light scattered will be at a different frequency. The frequency or intensity of this scattered light or radiant energy will depend on the wavelength of the incident radiant energy, upon the difference in the refractive index of the particles with respect to the medium in which they are suspended, upon the size and shape of the particles and upon the angle at which the scattered energy is observed.

In other words, one of the things that the shift in the light frequency of scattered light is related to is the size of the particles causing the shift. As was set forth herein above, the smaller particles move faster. They have a higher average velocity, which in turn causes a greater shift in the light frequency than the shift caused by the larger particles. It is this difference in the frequency of scattered light among the particles of different sizes that is used to determine the size of the particles present.

Light Scattering techniques can be separated into static light scattering and dynamic light scattering. Static light scattering measures the intensity of the scattered light, I(q), as a function of the scattering angle. Static light scattering has been used to measure the equilibrium structure factor, the particle form factor, the molecular weight and the thermodynamic quantities such as the radius of gyration and the second virial coefficients in polymer solutions.

Dynamic light scattering, in turn, measures the decay of the intensity fluctuations via the intensity auto-correlation function G(q,t). It can provide a convenient way to measure diffusion coefficients of macromolecules in dilute solutions and the dynamics of polymers in solutions of varying concentrations.

Light scattering techniques have found great application in many types of industrial and health oriented activities. For example Wyatt, U.S. Pat. No. 4,693,602 and Wyatt, U.S. Pat. No. 4,548,500 disclose the use and improvement of light scattering techniques for measurement and counting of aerosol, and to a lesser extent, hydrosol properties for the purpose of maintaining the cleanliness of so-called manufacturing clean rooms. Such clean rooms can include areas where very large scale integrated circuits are manufactured, asbestos removal work areas, operating rooms, laboratories, and pharmaceutical production areas.

Likewise, Wyatt, U.S. Pat. No. 4,541,719 discloses the use and improvement of light scattering techniques for the characterization of a particle or an ensemble of particles as a means for guaranteeing the quality of beverages, the consistency of chemical reactions, the integrity of the food industry, the efficacy of antibiotic chemotherapy, the determination of adulterants and/or toxicants in food and water supplies. As for Wyatt, U.S. Pat. No. 4,490,042, it discloses the use of light scattering techniques in connection with the evaluation of the quality of wine.

The prior art apparatus used in light scattering studies generally comprises: an incident source of light; a sample or scattering cell; a lens located outside the sample or scattering cell, on the side of the incident light source, but interposed between the incident source of light and the scattering cell, so that it is in the pathway of the incident light source; and a photodetector. FIGS. 11, 12 and 13 marked prior art shows at least three different schematics of the prior art apparatus traditionally used in light scattering studies. The process of using the prior art light scattering apparatus includes the steps of using the incident source of light to generate a beam of light, focusing said beam of light using the lens through a first opening on the incident light source side wall of the sample or scattering cell and out of a second opening on the sample cell wall directly opposite and across the first opening, insuring that the beam at the focal point of the lens inside the sample cell or scattering cell enters the suspension fluid at a zero degree angle relative to the axis of the lens or the path of the incident beam fashion and collecting the scattered light generated by the contents of the sample cell using the photodetector.

The incident light source can be any number of lasers because of their properties of coherency, high monochromaticity, and ability to reach extremely high powers. Coherency is a property of wave-like states that enables a laser to exhibit interference. As most commonly used, interference usually refers to the interaction of waves which are correlated with each other either because they come from the same source or because they have the same or nearly the same frequency. Thus, a typical laser emits light in a narrow and well defined beam and with a well defined wavelength or color that is extremely useful as an incident light source in light scattering studies.

Some of the lasers used in light scattering techniques include but are not limited to gas lasers such as helium-neon lasers which emit light having wavelengths of 543 nm and 633 nm; argon-ion lasers capable of emitting light having wavelengths of 458 nm, 488 nm, and 514.5 nm; Helium-Silver lasers capable of emitting light having a wavelength of 224; and neon-copper lasers capable of emitting light having a wavelength of 248 nm.

The lens that is interposed between the incident light source, i.e. the laser, and the scattering cell is preferably a plano-convex lens. It is capable of taking the collimated or parallel beam of light generated by the laser and traveling parallel to the lens axis and passing through the lens and converging it (or focusing it) to a spot on the axis of the lens at a certain distance behind the lens (known as the focal length) and found within the light scattering cell where it hits the particles that are suspended in the suspension fluid within the light scattering cell.

The sample or scattering cell holds the specimen of particles that are to be analyzed and tested. Prior to being placed in the sample or scattering cell, the particles are dispersed in an appropriate suspension fluid. Any one of the many types of sample cells or scattering cells available in the market for light scattering techniques can be used, depending on the light scattering application for which the sample cell will be used. For example it can be the scattering cell disclosed in the Trundle U.S. Pat. No. 3,700,338, which provides a light scattering cell with an inexpensive optical surface that may be disposed of when it is scratched or otherwise damaged; that may be rapidly changed when the need arises; that minimizes angular distortion; and that minimizes unwanted absorption, refraction and reflection. Such scattering cell comprises a cell machined from a length of cylindrical metal tubing or similar material having a light entrance and viewing apertures. The optical surfaces over the apertures are formed from a thin transparent disposable film which is clamped around the outside of the cylindrical metal tubing (pipe).

Alternatively, it can be the scattering cell or straight path sample cell disclosed in Wertheimer, U.S. Pat. No. 4,265,538 which has the ability to provide a structure that makes possible the measurement of the forward scattered light and the 90 degree scatter in two orthogonal directions without the introduction of wells, insertions, or bends in the sample stream, which can create turbulence. The cell structure has an entrance and an exit window, which respectively form a front and back for the cell, so that the incident light beam is received by the front and the forward scattered light is transmitted through the back as one of the components. The cell also has a prism means with at least one of its faces optically contacting the sample along a side of the cell. Two other faces of the prism means are oriented so that they each pass another component of the scattered light.

Still yet, it can be the scattering cell or sample cell disclosed in Phillips et. al. U.S. Pat. No. 4,616,927 which permits the measurement of the light scattering properties of very small liquid-borne sample with negligible background interference from the illumination source. It comprises a right cylinder with a hole bored through a diameter. The cylinder and hole are optically polished and the cylinder is surrounded by an array of detectors lying in the plane of the hole and parallel to the base. Means are provided for introducing and removing a particle bearing sample fluid. The sample introduced into the hole thereby can be illuminated by a collimated light beams whose diameter is much smaller than the diameter of the hole. This beam passes directly through the hole and enters and leaves the cell by means of special windows mounted externally to the cell. Because of the slight difference of refractive index between the fluid and the surrounding glass cell, very little stray or background light enters the detectors, even at very small scattering angles. The invention also provides means for attenuating small angle scattered intensities which are a source of detector saturation in conventional light scattering instruments.

Or, if the light scattering technique used is dynamic light scattering then the scattering cell or sample cell can be the one disclosed by Freud et. al, U.S. Pat. No. 5,485,270. It comprises a cell housing and a cell chamber, the cell chamber being formed within the cell housing such that the cell chamber is exposed to a membrane which is capable of retaining within the cell chamber the particles of a sample introduced into the cell chamber while allowing a liquid carrier to diffuse across the membrane and an out of the cell chamber.

Or, still, it can be the modified light scattering cell disclosed in Wyatt et. al U.S. Pat. No. 5,530,540 whereby an eluant of a very small dimension, transverse to its direction of flow, is entrained successively by two sheath flows and presented to a fine light beam that illuminates the entrained eluant as it flows though the light beam. The light scattered by the entrained eluant is collected by detectors outside of a transparent flow cell enveloping the sheath flow entrained eluant. The windows of the transparent flow cell through which the light beam enters and leaves are far removed from the scattering eluant and kept clear of eluant contained particles by means of flow components that will form subsequently one of the eluant sheath flow employed. The eluant source is typically for a fine capillary such as found in capillary electrophoresis, capillary hydrodynamic fractionation and flow cytometry applications.

Likewise, the photodetector can be any one of the many photodetectors available for light scattering techniques, in the market today. Generally, the photodetector is a sensor of light or other electromagnetic energy. It acts to collect all of the scattered light beams generated by the fluid suspended particles, in the pathway of the laser beam, at the focal point of the lens inside the sample or scattering cell; and to convert them into a signal that can be measured and interpreted. At its most basic, the photodetector comprises some sort of optic and electronic system that responds to photons hitting it, produces a current, and converts the current into a voltage.

The optic and electronic system that responds to photons hitting it to produce a current can be a photo diode detector. It can comprise an optic lens system that guides the scattered light onto the photodiode. The photodiode is a semi-conductor diode that functions as a photodetector. A diode is basically a component that restricts the direction of flow or charge carriers such as electrons or ions. Essentially it allows an electric current to flow in one direction, but blocks it in the opposite direction. Thus, a diode is essentially an electronic version of a check valve. A photodetector is a sensor of light or other electromagnetic light. It is usually provided either with a window or an optical fiber connection so that it can let in the light to the sensitive part of the device where it excites electrons and creates a current. The current is then converted into voltage, using the current-to-voltage converter, which voltage is used to record and interpret the results of shining the laser beam on the suspended particles in the sample or scattering cell.

Or, the optic and electronic system that responds to photons hitting it to produce a current can be a photomultiplier. A photomultiplier is an extremely sensitive detector of light in the ultraviolet, visible and near infrared wavelengths of light. This detector multiplies the signal produced by light that hits it as much as 10⁸, from which single photons can be resolved. It comprises a photocathode, several dynodes and an anode. The photocathode is a negatively charged electrode coated with a photosensitive compound. When it is struck by light, it emits electrons. A dynode is one of a series of polished metal electrodes within the photomultiplier. Each dynode is more positively charged than its predecessor. Secondary emission occurs at the surface of each dynode. In other words, the electrons emitted from the photocathode, as a result of being hit by photons, are accelerated towards the dynode where if they strike with sufficient energy, they will knock off many more electrons from the surface of the dynode. These new electrons are then accelerated toward another dynode where even more electrons are emitted. This process occurs typically ten or so times. The result is that the tiny and normally undetectable current from the photocathode becomes a larger and more easily measurable current flowing in the final anode circuit. In fact, by the time this process has been repeated at each of the dynodes, 10⁵ to 10⁷ electrons have been produced from each incident photon that hits the photocathode. The anode is an electrode through which electric current flows into a polarised electrical device, such as a current-to-voltage converter.

Finally, the optic and electronic system that responds to photons hitting it to produce a current can be an avalanche photodiode. An avalanche photodiode is a photodetector that can be regarded as the semiconductor analog to a photomultiplier. By applying a high reverse bias voltage (typically 100-200 V in silicon) an avalanche photodiode can show an internal current gain effect (around 100) due to impact ionization (avalanche effect). Impact ionization in an avalanche photodiode is the process by which a photon is absorbed to create electrons. If the absorption occurs in a region of high electrical field then it can result in an avalanche breakdown, a process that is exploited in an avalanche photodiode to provide gain. Avalanche breakdown is a phenomenon, a form of electric current multiplication that can allow very large currents to flow. However, the avalanche current must be limited if the avalanche breakdown is to work successfully without any breakdown.

The process of using the light scattering apparatus described herein above is fraught with problems and opportunities for errors and in the particle light scattering results These errors in turn can lead to many erroneous conclusions in connection with the particles being studied. As a result, since the inception of light scattering technology it has been imperative to address these problems and minimize the opportunities for errors in the data generated and the conclusions made there from.

The errors arise from the background effects or contributions created by the sample cell or scattering cell itself (hereinafter “the sample cell”), and from the suspension fluid. For example, one background effect arises at the entrance point of the beam through the first entrance opening in the sample cell. The refractive index of the material covering such first entrance point can be silica, quartz, glass or even plastic. The refractive index of such materials is different from the refractive index of the outside environment through which the beam travels before it enters the sample cell, and different from the suspension fluid in which the particles are dispersed, inside the sample cell. As a result the beam of light entering the cell gets bent as it travels from the outside environment through the material covering the first opening in the sample cell and then gets bent again as it travels through the suspension fluid. Consequently, the chances that the beam of light will enter into the suspension fluid at a zero degree angle relative to the axis of the lens or the path of the incident light beam is much lower than theorized.

Another background effect arises from the light scattering effects of the impurities contained in the materials covering the first entry opening of the sample cell, the second exit opening of the sample cell, the walls themselves of the sample cell, and the suspension fluid, itself. As pure as such materials and fluids can be made, they will still contain impurities. For example, an article entitled “Liquid Phase Particulate Contaminants in Water” by Wilbur Kay, Journal of Colloid and Interface Science, Volume 46, No. 3, March 1974 pages 543-44, describes the range of contaminants which have been encountered in pure water. Thus, as the light beam hits the particles dispersed in the suspension fluid it will also hit these impurities. Just as the dispersed particles will cause the light beam to scatter, so too will the impurities cause the light beam to scatter. The impurities' light scattering can very well mask or add to the light scattering of the particles themselves leading to errors in the results.

Yet another background effect can arise from the light exiting the second exit opening of the sample cell, opposite to and coaxial to the first entry opening. Some of the light traveling through the suspension fluid will not necessarily make it out the second exit opening. Partly as a result of hitting the particles themselves and partly because of the refractive index of the suspension fluid and partly because of the spreading of the beam of light through the suspension fluid, it will hit the walls of the sample cell framing and forming the outer perimeter or edges of the second exit opening. When it does, it will bounce back or reflect back into the suspension fluid, thereby further masking the light scattering results of the particles and further skewing the results therefrom.

Still another background effect can arise from air bubbles. Some liquids, notably water, will not wet, clean silica surfaces easily. If air does get into the sample cell, it will form at least one air bubble on any one of the silica windows covering the openings of the sample cell. This air bubble acts like a lens scattering the incident light or even the exiting light, rendering meaningful measurements impossible.

Some of the prior art has attempted to provide solutions for the elimination of the errors that can arise as a result of the background effects created or contributed by the sample cell, or the suspension fluid. One technique has been to stream the particle-containing/suspension fluid specimen through a small circular orifice, perpendicularly, i.e., across the pathway of the light beam generated by the incident light source. This works quite well for aerosols, where the air stream carrying the particles has essentially no focusing power. However, it does not work so well with hydrosols, i.e., particles suspended in liquids, because the liquid stream spreads the incident light beam, which can both mask the particles' scattered light and distort it.

While Wallace, U.S. Pat. No. 4,178,103 appears to have solved the problem of streaming hydrosols through a small orifice across a laser beam, such solution is of limited application. It does not address those applications where streaming does not work. Nor does any of the prior art address the effects of conducting light scattering analysis with a probe. Finally, none of the prior art suggests or focuses on providing any solutions to the problem of sample cell and suspension fluid background effect contribution by changing the anatomy and configuration, as well as the positioning, of the lens itself relative to the suspension fluid and the particles diffused therein.

Accordingly, there clearly still is a need for an apparatus and method that can address the problems of masking or skewing of particle light scattering results, by the background effects created or contributed by the sample cell itself, and/or the suspension fluid. Without such apparatus and method errors will continue to exist, or at least suspected to exist; confidence in the light scattering results and the scientific conclusions arising therefrom will remain at relatively the same level as currently existing; and light scattering technology will continue to exist on the fringes of industry and science application, as a research and development tool, instead of being widely accepted as a tool for quality control and consistency in the infinite number of areas, limited only by imagination, where it might find application.

### OBJECTS OF THE INVENTION

IT IS THEREFORE AN OBJECT of the present invention to minimize the inherent problems and errors arising therefrom, in light scattering technology applications, not heretofore effectively addressed by the prior art.

IT IS ANOTHER OBJECT of the present invention to minimize, if not totally eliminate, those errors in the results of light scattering technology applications, that arise from the background effects created or contributed by the sample cell, i.e., the coverings of the entry and exit openings of the sample cell, and the walls thereof.

IT IS ANOTHER OBJECT of the present invention to minimize, if not totally eliminate, those errors in the results of light scattering technology applications, that arise from the background effects created or contributed by the suspension fluid.

IT IS YET ANOTHER OBJECT of the present invention to minimize, if not totally eliminate, any and all refractive index effects on the light beam generated by the incident light source, as the light beam travels and transitions from one medium and into another.

IT IS STILL ANOTHER OBJECT of the present invention to generate a light beam that will, more likely than not, enter the suspension fluid at a zero degree angle relative to the axis of the lens and the incident path of the light beam.

IT IS A FURTHER OBJECT of the present invention to minimize, if not completely eliminate, the light scattering masking of particles' light scattering results, effectuated by the impurities found in the sample cell, i.e., the coverings of the entry and exit openings of the sample cell, and the walls thereof; and the impurities found in the suspension fluid.

IT IS YET A FURTHER OBJECT of the present invention to minimize, if not completely eliminate, the light scattering masking of particles' light scattering results, effectuated by the reflection or bouncing back into the suspension fluid, of light not successfully exiting the sample cell.

IT IS STILL A FURTHER OBJECT of the present invention to minimize, if not completely eliminate, the light scattering masking of particles' light scattering results, effectuated by air bubbles trapped in the sample cell or in the suspension fluid.

ANOTHER OBJECT of the present invention is to provide an apparatus and method that can be incorporated into a light scattering sample cell, for both static and dynamic light scattering applications.

IT IS ANOTHER OBJECT of the present invention to provide a light scattering sample cell suitable for the use of micro-volumes of samples of liquid-suspended particles, during a flow-through, dynamic light-scattering analysis of said particles.

IT IS ANOTHER OBJECT of the present invention to eliminate the need for large volume samples of liquid-suspended particles, during a flow-through, dynamic, light-scattering analysis.

IT IS YET ANOTHER OBJECT of the present invention to permit the use of truly micro-volume samples of liquid-suspended, hazardous particles during batch mode, dynamic light scattering analysis.

IT IS STILL ANOTHER OBJECT of the present invention to provide a dynamic, light-scattering flow cell and method for use in both batch and flow-through modes of dynamic, light-scattering analyses using truly micro-volume samples of liquid-suspended particles.

IT IS A FURTHER OBJECT of the present invention to provide a dynamic, light-scattering flow cell and method for use in both batch and flow-through modes of dynamic and static, light-scattering analyses, which flow cell and method permit a high pressure seal, without the use of additional seals, gaskets, windows or other sealing compounds (e.g. epoxy, silicone or similar) on the walls thereof.

IT IS YET A FURTHER OBJECT of the present invention to provide a dynamic, light-scattering flow cell and method for use in both batch and flow-through modes of dynamic and static, light-scattering analyses, which flow cell and method do away with the need to find a broad range of chemically compatible, broad range temperature, insensitive seals, gaskets or sealing compounds.

IT IS STILL A FURTHER OBJECT of the present invention to eliminate the need for refractive index matching or refractive index correction during both batch and flow-through modes of dynamic and static, light-scattering analyses, because the surface of the lens through which a laser is focused into a micro-volume sample of liquid-suspended particles is in direct contact with said sample.

IT IS ANOTHER OBJECT of the present invention to provide an apparatus and method that can be incorporated into a light scattering probe capable of minimizing, if not totally eliminating the light scattering masking of particles' light scattering results, effectuated by a densely populated or minimally populated suspension fluid, and the impurities thereof.

IT IS YET ANOTHER OBJECT of the present invention to minimize, if not completely eliminate, the light scattering masking of particles' light scattering results, effectuated by the impurities found in the sample cell, i.e., the coverings of the entry and exit openings of the sample cell, and the walls thereof, and the impurities found in the suspension fluid through the use of a spherical or ball lens.

IT IS STILL ANOTHER OBJECT of the present invention to produce particles' light scattering results and scientific conclusions therefrom, that inspire the scientific community with confidence regarding their precision and accuracy, and the good and services community regarding their widespread application to any and all industries at large.

These objects, as well as other objects and advantages will become more apparent in the description that is set forth herein below, particularly when read in conjunction with the accompanying drawings.

### SUMMARY OF THE INVENTION

The inventive optical spherical lens light scattering apparatus and method for use thereof comprises an incident light source, a spherical or ball optical lens system and a photo detector. The spherical or ball lens optical system comprises at least one ball or spherical lens being in direct contact with the specimen of particles to be tested dispersed in a suspension fluid; said ball lens having, as a result of its spherical geometry, and as compared to a plano-convex or convex lens, a relatively short focal point. When the incident light source is used to generate a beam of light, and the beam of light is then focused through the spherical or ball lens, it lands at a point that is much closer to the lens, as compared to the point it would normally land on, when it is focused through a plano-convex, or a convex lens. It is the proximity of the spherical or ball lens' focal point to the spherical or ball lens itself, the contact of the ball lens to the suspension fluid containing the particles to be tested, and the placement of the specimen of particles dispersed in the suspension fluid within such focal point, that minimizes, if not eliminates all light scattering masking of particles' light scattering results.

The inventive method for use of the inventive optical spherical lens light scattering apparatus comprises at least the following steps: (i) using an incident light source to generate a beam of light or a beam of energy having a certain wavelength and frequency; (ii) focusing the beam of light or beam of energy through a spherical or ball lens; (iii) placing a specimen of particles, dispersed in a suspension fluid, directly in the focal point of the spherical lens, so that the focused beam of light or focused beam of energy hits the suspended particles at exactly the focal point of the spherical or ball lens, and the suspended particles scatter the beam of light; and (iv) directing the scattered light through a spherical or ball lens onto a photodetector.

In one embodiment of the inventive optical spherical lens light scattering apparatus, the spherical or ball lens optical system is integrally but removably fixed on the walls of a sample cell to form part of the walls thereof and be in direct contact with the specimen of particles dispersed in a suspension fluid. More specifically, the sample cell utilizing the spherical or ball lens optical system, comprises a cell block having: an inner, centrally enclosed, hollow chamber; at least three, through-bores placed on the same plane, each of said through-bores beginning at the outer surface of the cell block and ending at and opening into said inner, centrally enclosed, hollow chamber; two of said through-bores juxtaposed, end to end, so that their longitudinal axes are along the same line, but spaced apart the full width of said inner, centrally enclosed, hollow chamber, such that their openings into said inner, centrally enclosed, hollow chamber are positioned exactly across from each other, at opposite walls of said inner, centrally enclosed, hollow, chamber, whereby one of said two, juxtaposed through-bores can act as an incident light through-bore and the other of said two, juxtaposed through-bores can act as an exiting light through-bore; said remaining third through-bore interposed between said two, end to end, juxtaposed through-bores, so that its longitudinal axis is perpendicular to the co-aligned longitudinal axes of the two juxtaposed through bores, and its opening into said inner, centrally enclosed, hollow, chamber is approximately equidistant from the openings of the juxtaposed through-bores, at the opposite walls of said inner, centrally enclosed, hollow chamber, whereby it can act as a measurement through-bore; at least three, spherical or ball lenses, each of said spherical or ball lenses removably and frictionally fixed within each of said through-bores ending at and opening into said inner, centrally enclosed, hollow, micro volume chamber, such that said spherical or ball lenses completely fill and seal said through-bores and partially form the walls of the inner, centrally enclosed, hollow, chamber; and a sample entry port and a sample exit port, both funnel shaped, with each of their wider ends placed on the outer surface of the cell block and each of their narrow tips leading into and terminating at the inner, centrally enclosed hollow chamber.

The process of utilizing the sample cell utilizing the spherical or ball lens optical system comprises the following steps: installing the inventive sample cell on the chassis or base of a light-scattering detector; communicatingly connecting a fiber optic system via an optical detecting fiber to said measuring through-bore of the inventive sample cell; by using the appropriate hardware, supplying power and generating a focused beam of light; optionally adjusting the temperature of the light beam generating module for the purpose of maintaining the stability of the light beam intensity during the use of the inventive sample cell; simultaneously focusing the light beam both through the entry through-bore and the spherical or ball lens frictionally but removably fixed at said entry through-bore, adjacent to said inner, centrally enclosed, hollow, chamber; via the sample entry port filling the inner, centrally enclosed, hollow, chamber, either manually or via a pump system, with a sample of liquid suspended particles needing to be measured and characterized; focusing the beam of light through the incident light through-bore and through its corresponding spherical or ball lens onto the sample of liquid suspended particles and out the exiting through-bore and its corresponding spherical or ball lens, adjacent to the inner, centrally enclosed hollow chamber. The molecules or particles within the laser beam's path scatter light. The spherical or ball lens located at the opening of the measurement through-bore, between the incident through-bore and the exiting light through-bore spherical ball lenses, collimates the scattered light which is then refocused onto the detecting fiber, i.e., the scattered light intensity is picked up by the optical detector via a fiber optic system, and converted to provide data that generates information regarding the physical characteristics and chemical properties of the liquid-suspended particles filling the chamber.

In another embodiment of the inventive optical spherical lens light scattering apparatus, the spherical or ball lens optical system is integrally but removably fixed on the lower end of a light scattering probe to form part of the lower end wall thereof and be in direct contact with the specimen of particles dispersed in a suspension fluid, when the probe is immersed therein. More specifically, the light scattering probe utilizing the spherical or ball lens optical system, comprises a body, preferably cylindrical having: an inner, centrally enclosed, hollow core formed by a single through-bore beginning at the outer surface of the lower end of the body; at least one, spherical or ball lens removably and frictionally fixed within said through-bore ending at said lower end of said body, such that said spherical or ball lens completely fills and seals said lower end of said through-bore and partially forms the lower wall of the probe, thereby completely sealing the inner, centrally enclosed, hollow, core of the probe to create a cavity therein; an incident light source and at least one optical detecting fiber enclosed within said inner, centrally enclosed hollow core of the probe; and a photodetector.

The process of utilizing the probe, having the spherical or ball lens optical system, comprises the following steps: communicatingly connecting the at least one optical detecting fiber to said photodetector; supplying power and using the incident light source within the inner chamber of the probe to generate a focused beam of light; focusing the light beam on the spherical or ball lens, frictionally but removably fixed at said lower end of the probe sealing the through-bore, such that the beam penetrates and enters the spherical or ball lens at a zero degree angle relative to the path of said incident light beam; immersing the probe into a sample of liquid suspended particles needing to be measured and characterized; focusing the beam of light through its corresponding spherical or ball lens onto the sample of liquid suspended particles. The molecules or particles within the laser beam's path at the focal point of the spherical or ball lens, and adjacent thereto scatter light. The spherical or ball lens then collimates the scattered light and focuses it back through said spherical or ball lens, onto the detecting fiber, which in turn is sends it to the photodetector and converts to provide data that generates information regarding the physical characteristics and chemical properties of the liquid-suspended particles in the specimen, in which the probe was immersed.

### BRIEF DESCRIPTION OF THE DRAWINGS

While the specification shall conclude with claims which will particularly point out and distinctly claim the present invention, it is believed that the present invention will be better understood from the following detailed description taken in conjunction with the accompanying drawings in which like numerals represent identical elements and wherein:

FIG. 1 is a plan view generally showing one of the many environments that the inventive optical spherical or ball lens light scattering apparatus can be installed into for use in a flow-through mode, laser, light-scattering analysis;

FIG. 2 is a three-dimensional perspective view of the inventive single chamber, light-scattering, sample cell comprising the inventive spherical or ball lens optical system installed in the laser, light-scattering detector of FIG. 1;

FIG. 3 is a three-dimensional perspective view of the inventive single chamber, light-scattering, sample cell comprising the inventive spherical or ball lens optical system, of FIG. 2;

FIG. 4 is a side plan view of the inventive, single chamber, light-scattering, sample cell of FIG. 3;

FIG. 5 is a top plan view of the inventive, single chamber, light-scattering, sample cell of FIG. 3;

FIG. 6 is a bottom plan view of the inventive, single chamber, light-scattering, sample cell of FIG. 3;

FIG. 7 is a section view of the inventive, single chamber, light-scattering, sample cell of FIG. 6 taken along A-A′ and showing an alternate embodiment having at least four through-bores and at least two measuring through-bores arranged along the x-axis;

FIG. 8 is a section view of the inventive, single chamber, light-scattering, sample cell of FIG. 6 taken along A-A′ and showing a first embodiment having at least three through-bores and at least one measuring through-bore arranged along the x-axis;

FIG. 9 is a section view of the inventive, single chamber, light-scattering, sample cell of FIG. 6 taken along B-B′ and showing an embodiment having at least three through-bores and with the incident through-bore and the exit through-bore arranged along the x-axis;

FIG. 10 is a three-dimensional perspective of an alternate embodiment of the inventive, single chamber, light-scattering sample cell, wherein there is a plurality of measuring through-bores.

FIG. 11 consists of various views of the inventive probe with the spherical or ball lens optical system within its inner hollow core.

FIGS. 12 through 14 Prior art plan views showing at least three different schematics of the prior art apparatus traditionally used in light scattering studies

FIG. 15 Plan view of schematic of one of the embodiments of the inventive optical spherical lens light scattering apparatus.

LIST OF ELEMENTS AND THEIR RESPECTIVE
IDENTIFYING NUMERALS

| NO | ELEMENT |
|---|---|
| 10 | The inventive optical spherical lens light |
| | scattering apparatus |
| 12 | Incident light source |
| 14 | Spherical or ball optical lens system |
| 20 | Cell block |
| 30 | Inner, centrally enclosed, chamber |
| 40 | Incident through-bore |
| 42 | Inner opening of incident through-bore |
| 50 | Exit through-bore |
| 52 | Inner opening of exit through-bore |
| 60 | Measuring through-bore |
| 62 | Inner opening of measuring through-bore |
| 70 | Incident Spherical or ball lens |
| 72 | Lens mount in probe |
| 80 | Exit spherical or ball lens |
| 90 | Measuring spherical or ball lens |
| 100 | Sample entry port |
| 110 | Sample exit port |
| 120 | Sample delivery tubing |
| 130 | Acorn nuts |
| 140 | Fiber Optic System |
| 142 | Fibers |
| 146 | Probe inner hollow core |
| 148 | Probe Stainless Steel Sleeve |
| 150 | Photodetector |
| 152 | Probe body |
| 154 | Probe upper end |
| 156 | Probe lower end |
| 158 | Probe through bore forming inner hollow |
| | chamber |

### DETAILED DESCRIPTION OF THE INVENTION

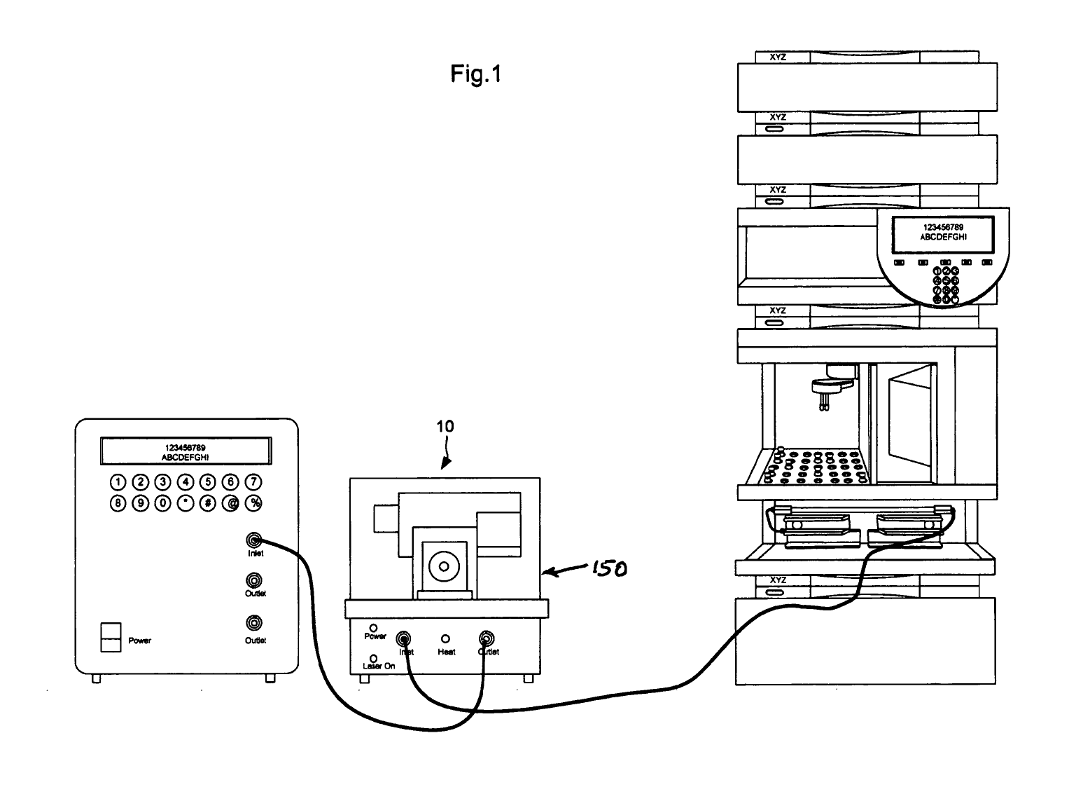

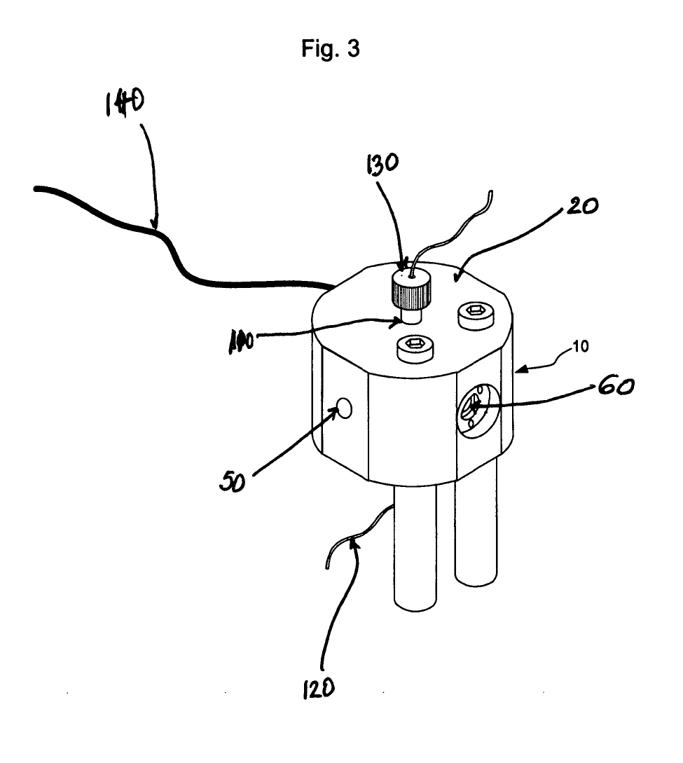

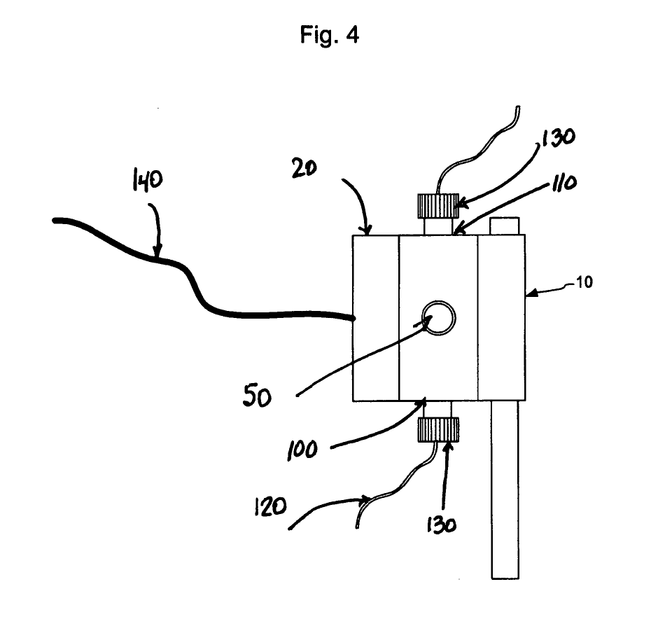

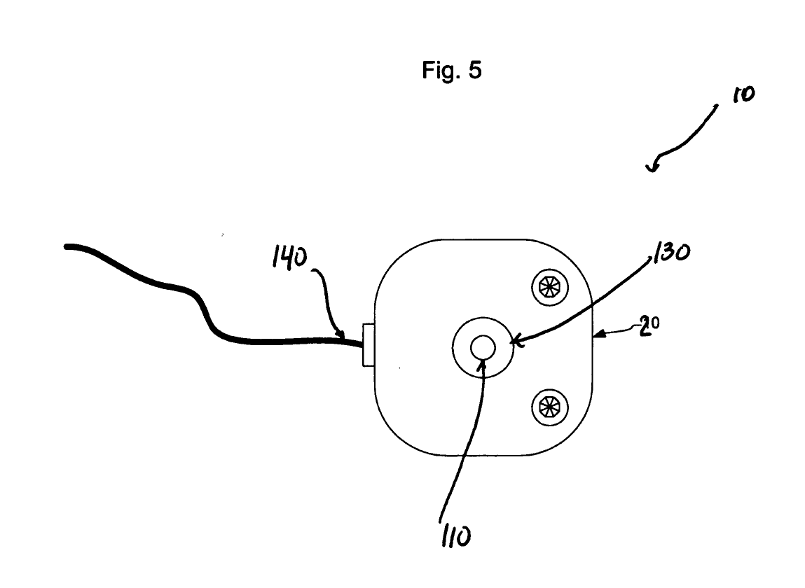

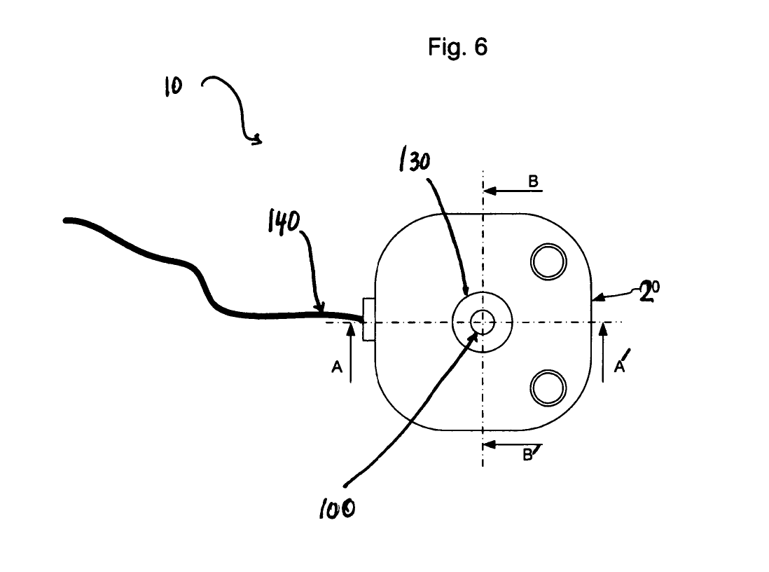

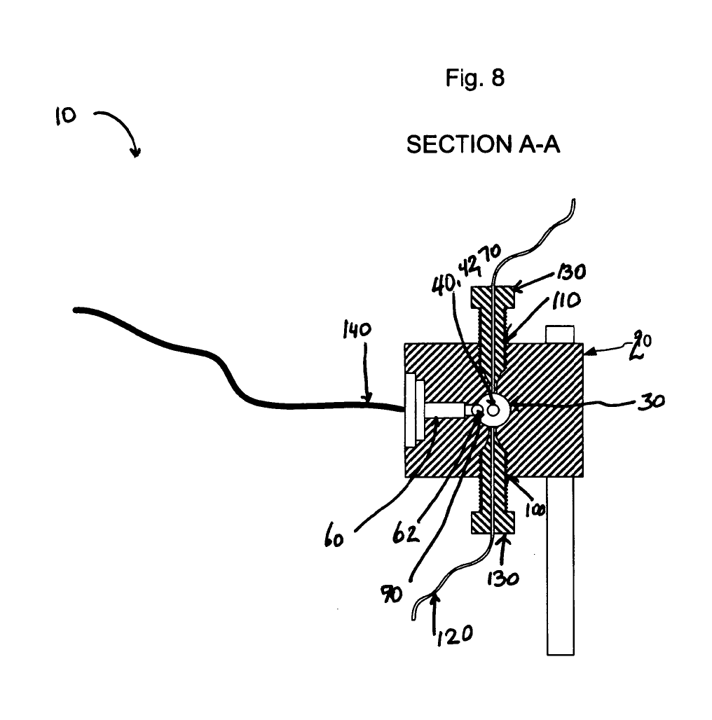

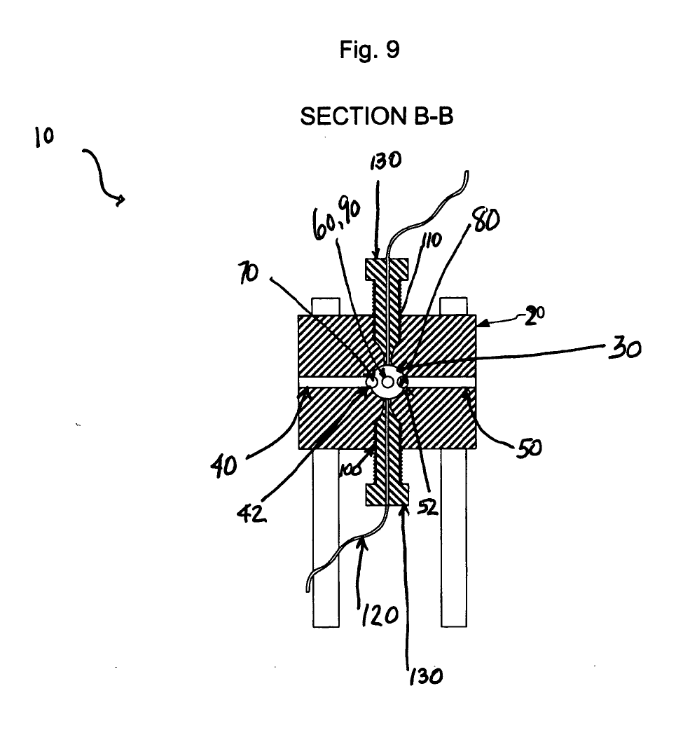

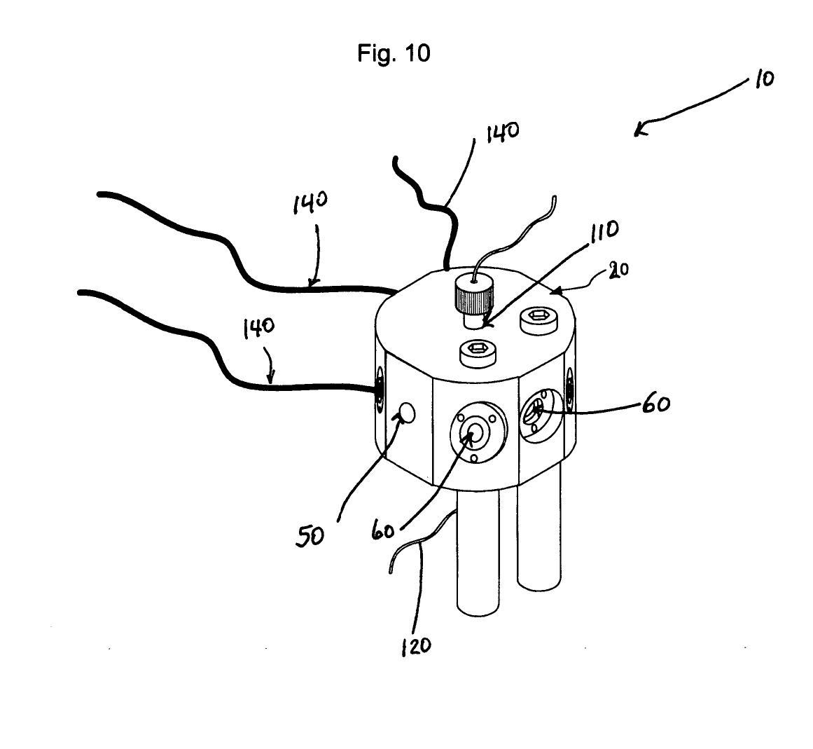

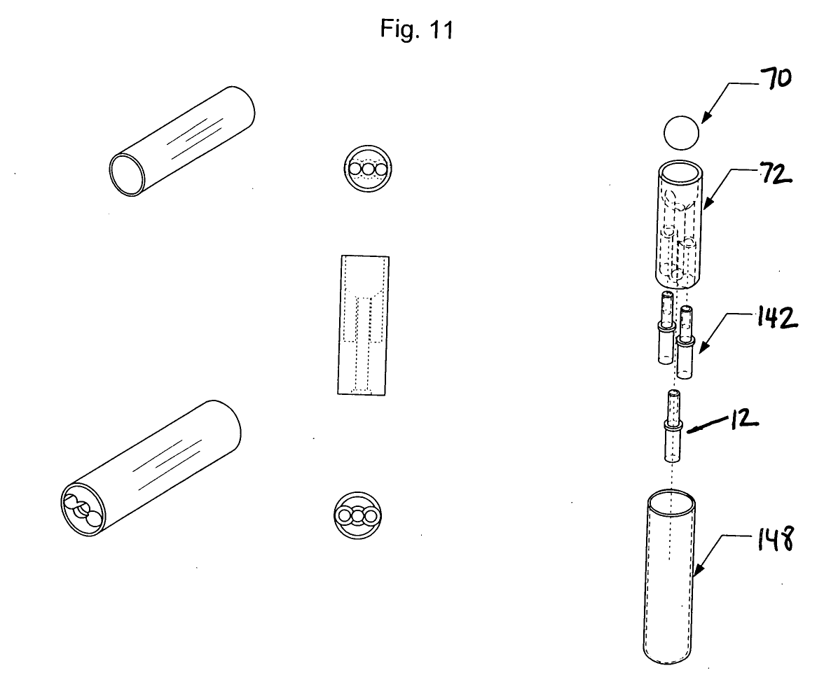

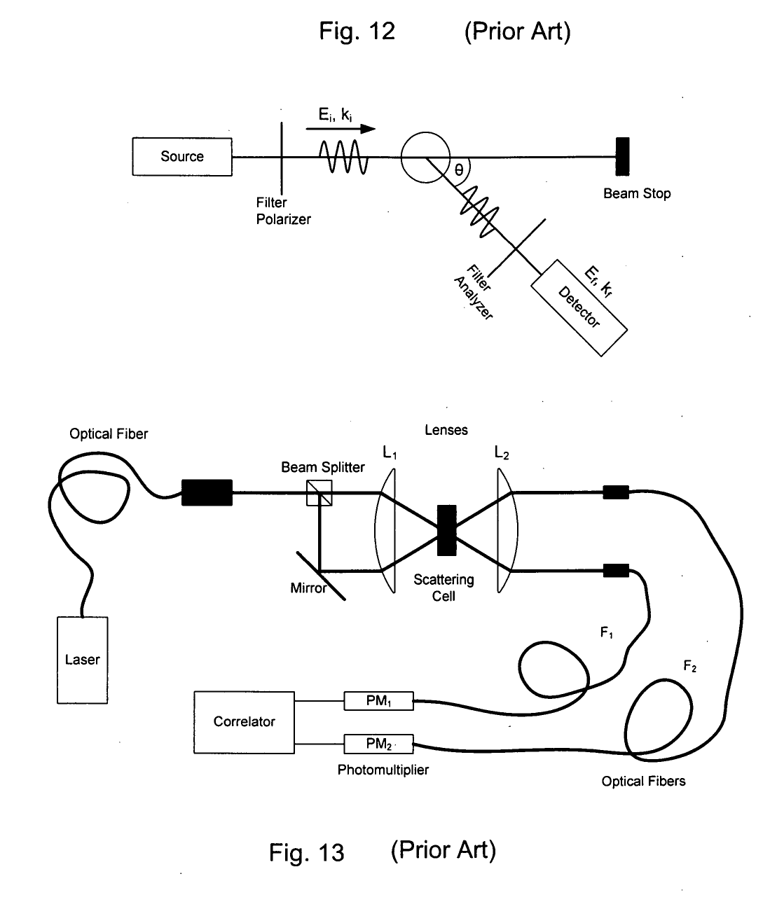

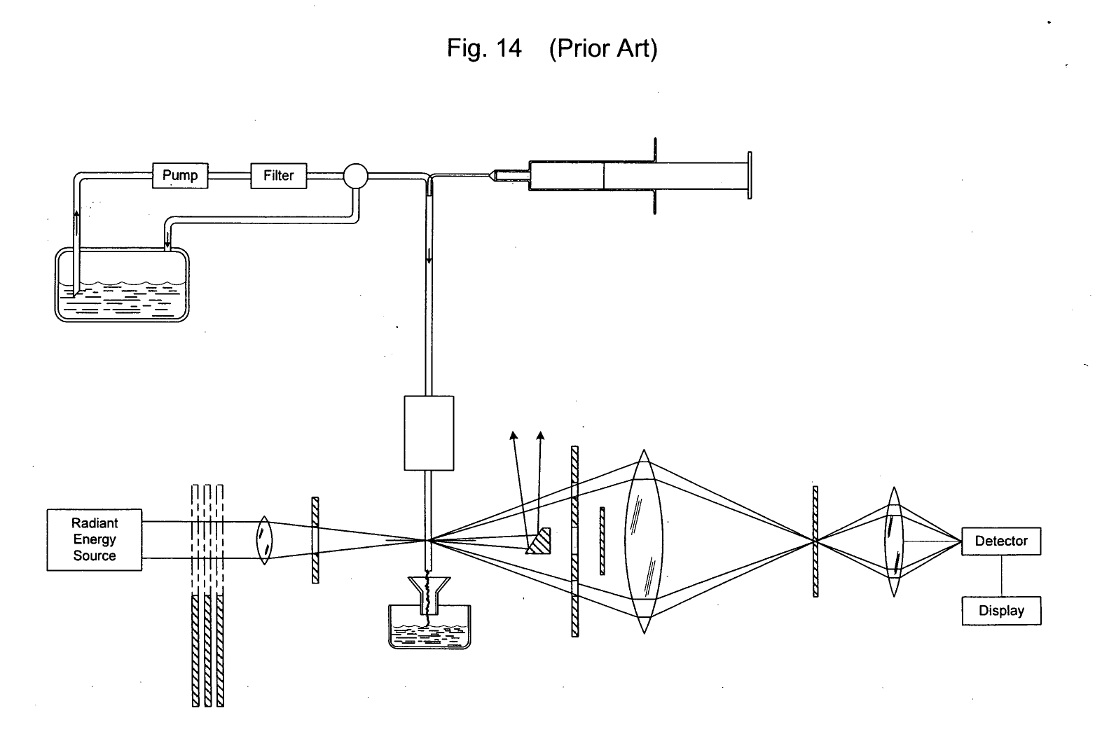

Referring more specifically to the drawings, FIGS. 1-10 on the one hand, and FIG. 11 on the other, depict at least two of the embodiments of the inventive optical spherical lens light scattering apparatus at 10, and methods for use thereof. They are designed to: (i) minimize, if not totally eliminate, those errors in the results of light scattering technology applications, that arise from the background effects created or contributed by the sample cell; (ii) minimize, if not totally eliminate, those errors in the results of light scattering technology applications, that arise from the background effects created or contributed by the suspension fluid; (iii) minimize, if not totally eliminate, any and all refractive index effects on the light beam generated by the incident light source, as the light beam travels and transitions from one medium and into another; (iv) generate a light beam that will, more likely than not, enter the suspension fluid at a zero degree angle relative to the incident path or axis of said light beam; (v) minimize, if not completely eliminate, the light scattering masking of particles' light scattering results, effectuated by the impurities found in the sample cell and the impurities found in the suspension fluid; (vi) minimize, if not completely eliminate, the light scattering masking of particles' light scattering results, effectuated by the reflection or bouncing back into the suspension fluid, of light not successfully exiting the sample cell; and (vii) minimize, if not completely eliminate, the light scattering masking of particles' light scattering results, effectuated by air bubbles trapped in the sample cell or in the suspension fluid.

The inventive optical spherical lens light scattering apparatus at 10 uses certain properties of light to determine, among other things, the size of particles, particle size distributions, and molecular weights. The term “particles” as being used herein, denotes objects whose size can range from macromolecule size at one extreme end of the spectrum, to large mammalian cell or even phytoplankton size at the other end. Macromolecule size in turn, can vary from one nanometer (one billionth (10⁻⁹) of a meter) in length to tens of micrometers.

The properties of light that the inventive optical spherical lens light scattering apparatus at 10 uses to determine particle size, are the light's wavelength and its frequency. Furthermore, the particles' properties that the inventive optical spherical lens light scattering apparatus at 10 uses are their ability to scatter light that is shone upon them. Specifically when a beam of radiant energy is incident upon a particle, a portion of this energy will be scattered in all directions. The frequency or intensity of this scattered light or radiant energy will depend on the wavelength of the incident radiant energy, upon the difference in the refractive index of the particles with respect to the medium in which they are suspended, upon the size and shape of the particles and upon the angle at which the scattered energy is observed. In other words, one of the things that the shift in the light frequency of scattered light is related to is the size of the particles causing the shift. As was set forth herein above, the smaller particles move faster. They have a higher average velocity, which in turn causes a greater shift in the light frequency than the shift caused by the larger particles. It is this difference in the frequency of scattered light among the particles of different sizes that is used to determine the size of the particles present.

The inventive optical spherical lens light scattering apparatus at 10 can be used both in static light scattering and dynamic light scattering. If it is used in static light scattering, it will measures the intensity of the scattered light, I(q), as a function of the scattering angle. These measurements can be used for the determination of the equilibrium structure factor, the particle form factor, the molecular weight and the thermodynamic quantities such as the radius of gyration and the second virial coefficients in polymer solutions. If it is used in dynamic light scattering, it will measure the decay of the intensity fluctuations via the intensity auto-correlation function G(q,t), which provides a convenient way to measure diffusion coefficients of macromolecules in dilute solutions and the dynamics of polymers in solutions of varying concentrations.

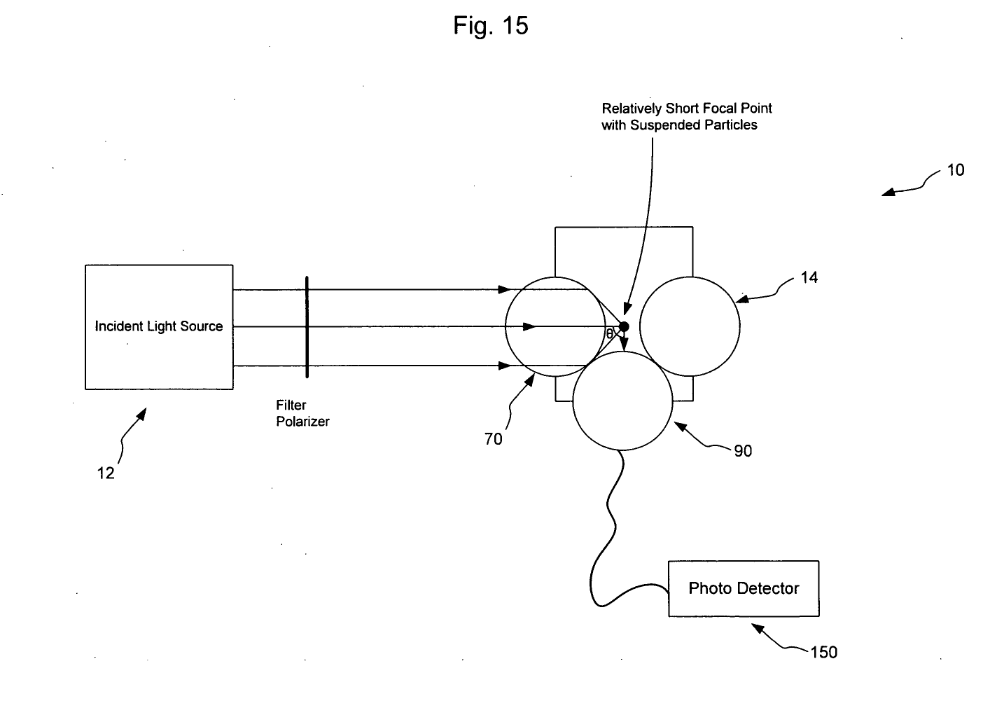

A schematic diagram of the inventive optical spherical lens light scattering apparatus at 10 and method for use thereof is shown at FIG. 15. It comprises: an incident light source 12, a spherical or ball optical lens system 14 and a photodetector 150. The spherical or ball lens optical system 14 comprises at least one spherical or ball lens 70 having, as a result of its spherical geometry, and as compared to a plano-convex lens or a convex lens, a relatively short focal point. When the incident light source 12 is used to generate a beam of light, and the beam of light is then focused through the spherical or ball lens 70, it lands at a point that is much closer to the lens 70, as compared to the focal point it would normally land on, when focused through a plano-convex, or a convex lens. It is the proximity of the spherical or ball lens' 70 focal point to the spherical or ball lens 70 itself, that minimizes, if not eliminates all light scattering masking of particles' light scattering results.

The incident light source 12 can be any number of lasers because of their properties of coherency, high monochromaticity, and ability to reach extremely high powers. They include but are not limited to gas lasers such as helium-neon lasers which emit light having wavelengths of 543 nm and 633 nm; argon-ion lasers capable of emitting light having wavelengths of 458 nm, 488 nm, and 514.5 nm; Helium-Silver lasers capable of emitting light having a wavelength of 224; and neon-copper lasers capable of emitting light having a wavelength of 248 nm.

The spherical or ball lens 70 that is interposed between the incident light source 12, i.e. the laser, and the specimen is preferably a spherical or ball lens. It is capable of taking the collimated or parallel beam of light generated by the laser 12 and traveling parallel to the lens axis and passing through the lens and converging it (or focusing it) to a spot on the axis of the lens at a very short distance behind the lens (known as the focal length). As a result, the light scattering volume is very close to the spherical or ball lens 70.

The photodetector 150 can be a photomultiplier, an avalanche photodiode, or a charge-coupled device (CCD) which is an image sensor consisting of an integrated circuit containing an array of linked, or coupled, light-sensitive capacitors.

The inventive method for use of the inventive optical spherical lens light scattering apparatus 10 comprises at least the following steps: (i) using an incident light source 12 to generate a beam of light or a beam of energy having a certain wavelength and frequency; (ii) focusing the beam of light or beam of energy through a spherical or ball lens 70; (iii) placing a specimen of particles, dispersed in a suspension fluid, at the focal point of the spherical or ball lens 70 or the scattering volume of the spherical or ball optical lens system, so that the focused beam of light or focused beam of energy hits the suspended particles at exactly the focal point of the spherical or ball lens 70 and the suspended particles scatter the beam of light; and (iv) directing that scattered light produced at a ninety degree angle to the axis of the lens through a spherical or ball lens 90 onto a photodetector 150.

Referring more specifically to the drawings, FIGS. 1-10 generally depicts one embodiment of the inventive optical spherical lens light scattering apparatus set forth herein above, i.e., an inventive, single chamber, light-scattering sample cell at 10, as used in a flow-through mode, laser, dynamic light-scattering analysis system. It is designed to achieve all of the objects set forth herein above, as well as: (i) allow the use of micro-volumes of samples of liquid-suspended particles, during the flow-through, laser, dynamic, light-scattering analysis of the particles; (ii) eliminate the need for large volume samples of liquid-suspended particles, during the flow-through, laser, dynamic, light-scattering analysis; (iii) permit the use of truly micro-volume samples of liquid-suspended, hazardous particles during both batch mode, laser, dynamic, light-scattering analysis; (iv) provide a laser, dynamic, light-scattering flow cell and method for use in both batch and flow-through modes of laser, dynamic, light-scattering analyses using truly micro-volume samples of liquid-suspended particles; (v) provide a laser, dynamic, light-scattering flow cell and method for use in the flow-through mode of the laser, dynamic, light-scattering analysis, which flow cell and method permit a high pressure seal, without the use of additional seals, gaskets, windows or other sealing compounds (e.g. epoxy, silicone or similar); (vi) provide a laser, dynamic, light-scattering flow cell and method for use in the flow-through mode of dynamic, light-scattering analysis, which flow cell and method do away with the need to find a broad range of chemically compatible, broad range temperature, insensitive seals, gaskets or sealing compounds; and (vii) eliminate the need for refractive index matching or refractive index correction during the flow-through mode of dynamic, light-scattering analysis.

The inventive single chamber, light-scattering sample cell at 10 enables, for the first time in the art, the use of extremely small volumes, i.e., micro-volumes, of 2 micro liters to 8 micro-liters of sample of liquid-suspended particles during flow-through, laser, dynamic, light-scattering analysis of said particles, by permitting the focusing of a laser beam within 0.5 mm of the lens surface of the flow-cell. This, in turn, allows for the gathering of a tremendous amount of information about said particles; information that heretofore could not be collected in a flow-through mode of laser, dynamic, light-scattering analysis due to the long focusing distances of the laser beam from the lens.

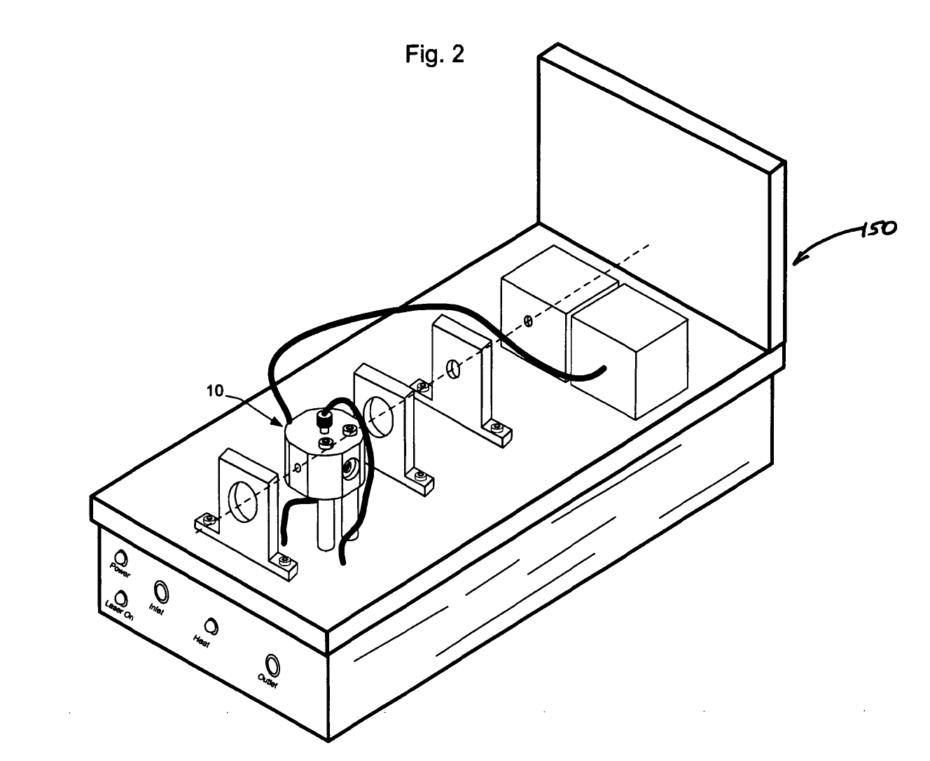

The inventive micro-volume, single chamber, laser, dynamic, light-scattering sample flow cell 10, as can be seen from FIG. 2 is removably inserted and fixed directly on the chassis, or base, or housing of a laser, dynamic, light-scattering photodetector 150. The photodetector can be used in both a flow-through mode and a batch mode, laser light-scattering analysis system.

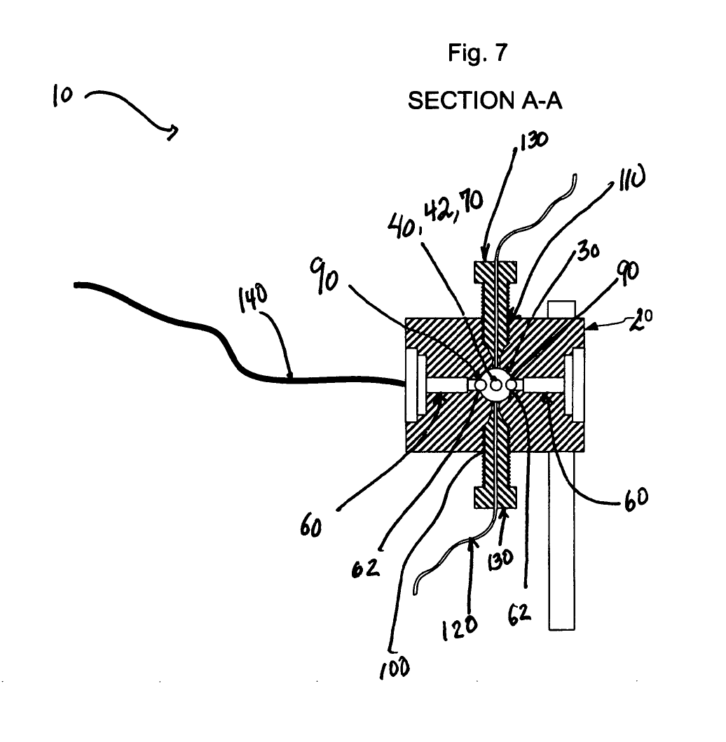

The inventive micro-volume, single chamber, dynamic, light-scattering sample flow cell 10 comprises a cell block 20. As can be seen from FIGS. 7, 8 and 9, the cell block 20 in turn, comprises an inner, centrally enclosed, hollow, micro-volume chamber 30, at least three, through-bores 40, 50 and 60, at least three, spherical or ball lenses 70, and 90, a sample entry port 100 and a sample exit port 110.

It is important that the cell block 20 be made of a material that permits a high pressure seal for all of the flow-cell's components, without the use of additional seals, gaskets, windows or other sealing compounds (e.g. epoxy, silicone or similar) and which does away with the need to find a broad range of chemically compatible, broad range temperature, insensitive seals, gaskets or sealing compounds. Furthermore, it has to be compatible with both the solvents in which the specimen particles are suspended, as well as be compatible with the specimen particles themselves. Finally, it must not break down, either physically or chemically, when coming in contact with the solvents and the specimen particles suspended therein, in a wide range of temperatures. One material that has the ability to provide all of the foregoing is Polyetheretherketone (PEEK).

In the preferred embodiment, the cell block is made of only PEEK. Not only is it compatible with a very wide range of solvent liquids and sample particles, but is also neutral in that it does not leach contaminants into the sample of liquid-suspended particles; even when it is exposed to temperatures ranging from 0 degrees C. to 160 degrees C.

Sealing in flow-through cells is a well documented problem. Sealing is necessary to continue to maintain the high pressure necessary for the analysis. Many times however, the materials used during the sealing process are incompatible with the chemical solvents used in the analysis of the specimen particles. Therefore, finding a broad range of chemically compatible, broad range temperature insensitive seal, gaskets or sealing compounds has always been a challenge. Use of PEEK in the cell block provides for a high pressure seal without the use of additional seals, gaskets, windows or other sealing compounds (e.g. epoxy, silicone or similar), thereby eliminating such challenge.

The cell block 20 comprises an inner, centrally enclosed, hollow, micro-volume chamber 30. The cell block 20 further comprises at least three, through-bores, an incident through-bore 40, an exit through-bore 50, and at least one measuring through-bore 60. The three through-bores are placed on the same horizontal plane, within the cell block 20. Each of said through-bores begins at the outer surface of the cell block 20, and terminates at an opening into said inner, centrally enclosed, hollow, micro-volume chamber 30. The incident through-bore 40 and the exit through-bore 50 are juxtaposed, end to end, so that their longitudinal axes are along the same line. However, they do not abut. Rather, they are spaced apart the full width of the inner, centrally enclosed, hollow, micro-volume chamber 30, such that their terminating openings 42 and 52 into said inner, centrally enclosed, hollow micro-volume chamber respectively, are positioned exactly across from each other, at opposite walls of the inner, centrally enclosed, hollow, micro-volume chamber 30. Thus, when a laser beam is focused through the incident through-bore 40, it enters into the inner, centrally enclosed, hollow, micro-volume chamber 30, and emerges out the exit through-bore 50.

Said measuring through-bore 60, in turn is interposed between said end to end, juxtaposed incident through-bore 40 and exit through-bore 50, so that the through-bore 60's longitudinal axis is perpendicular to the co-aligned longitudinal axes of the two juxtaposed through-bores 40 and 50, and its terminating opening 62, into said inner, centrally enclosed, hollow, micro-volume chamber is approximately equidistant from the terminating openings 42 and 52 of the juxtaposed through-bores 40 and 50 respectively, at the opposite walls of said inner, centrally enclosed, hollow micro-volume chamber.

The cell block 20, as set forth above, further comprises at least three spherical or ball lenses 70, 80 and 90 respectively. While a wide variety of spherical or ball lenses can be used, in the preferred embodiments the ball lenses are either rubies or sapphires due to their strength and purity. Their diameters range from 0.5 mm to 10 mm. Each of said spherical ball lenses 70, 80 and 90 respectively, is removably and frictionally fixed at each of the through-bores' terminating openings 42, 52 and 62 located on the walls of said inner, centrally enclosed, hollow, micro-volume chamber 30, The PEEK material of the cell block 20, has enough elasticity to give a bit when the spherical or ball lenses are pressed into the through-bores' terminating openings, but enough strength and resiliency to then wrap around said spherical or ball lenses, and seal them into place, without leaks or compromising the integrity of the inner, centrally enclosed, hollow, micro-volume chamber. Thus, as can be seen from FIGS. 7, 8 and 9, said spherical ball lenses, not only act as lenses for the laser beam, but also partially form and seal the wall of the inner, centrally enclosed, hollow, micro-volume chamber.

The cell block 20, further comprises a sample entry port 100 and a sample exit port 110. As can be seen from FIGS. 7, 8 and 9, their shape is generally funnel shaped. Each of their wider ends is placed on the outer surface of the cell block and each of their narrow tips leads into and terminates at the inner, centrally enclosed, hollow, micro-volume chamber 30. During use, the sample entry port 100 and the sample exit port 110 are penetrated by acorn nuts 130. The PEEK material of the cell block 20, has enough elasticity to give a bit when the acorn nuts are pressed to penetrate said sample entry port 100 and said sample exit port 110, but enough strength and resiliency to then wrap around the acorn nuts and seal them into place, without leaks or compromising the integrity of the inner, centrally enclosed, hollow, micro-volume chamber.

The acorn nut 130, which is inserted into the sample entry port 100, encloses a sample delivery tube 120 which is utilized to deliver a micro-volume of flowing sample of liquid suspended particles into the inner, centrally enclosed, hollow, micro-volume chamber 30. The internal volume of the chamber 30 ranges from 2 micro-liters to 8 micro-liters. Consequently, the amount of flowing sample of liquid-suspended particles that can be delivered into the chamber will also range between 2 and 8 micro-liters. Once the dynamic light scattering measurements of the liquid-suspended particles have been made, the specimen is removed from the chamber via a tubing bearing acorn nut 130 that has been inserted into the sample exit port 110.

The process of utilizing the inventive micro-volume, single chamber, dynamic, light-scattering sample flow cell 10 comprises the following steps:

installing the inventive flow cell 10 on the chassis or base, or housing of a dynamic, light-scattering detector 150;

communicatingly connecting a fiber optic system 140 via an optical detecting fiber 142 to said measuring through-bore 60 of the inventive flow cell 10;

by using the appropriate hardware such as a laser generating module, supplying power and generating a focused laser beam;

optionally adjusting the temperature of the laser generating module for the purpose of maintaining the stability of the laser beam intensity during the use of the inventive flow cell 10;

simultaneously focusing the laser beam both through the incident through-bore and the spherical or ball lens 70, frictionally but removably fixed at the terminating opening of said incident through-bore 40, adjacent to said inner, centrally enclosed, hollow, micro-volume chamber 30;

via the sample entry port 100, filling the inner, centrally enclosed, hollow, micro-volume chamber 30, either manually or via a pump system, with a flowing sample of liquid-suspended particles needing to be measured and characterized;

focusing the laser beam through the incident through-bore 40 and through its corresponding spherical or ball lens 70 onto the sample of liquid-suspended particles and out the exiting through-bore 50 and its corresponding spherical or ball lens 80, adjacent to the inner, centrally enclosed, hollow micro-volume chamber 30. The molecules or particles within the laser beam's path scatter light from the laser beam. The spherical or ball lens 90, located at the terminating opening 62 of the measurement through-bore 60, between the incident through-bore 40 and the exiting through-bore 50, collimates the scattered light which is then refocused onto the detecting fiber 142, i.e., the scattered light intensity is picked up by the optical detector via a fiber optic system, and converted to provide data that generates information regarding the physical characteristics and chemical properties of the liquid-suspended particles filling the chamber.

Referring more specifically to the drawings, FIG. 11 generally depicts another embodiment of the inventive optical spherical lens light scattering apparatus, i.e., an inventive, single chamber, light-scattering probe at 10, as used for example in batch mode, laser light-scattering analysis systems. It is designed to achieve all of the objects set forth herein above.

The inventive single chamber, light-scattering probe at 10 enables, for the first time in the art, the use of probe that permits the focusing of a laser beam within a very short distance from the lens surface. This, in turn, allows for the gathering of a tremendous amount of information. that heretofore could not be collected due to the long focusing distances of the laser beam from the lens.

The inventive single chamber, laser light-scattering probe 10, as can be seen from FIG. 11 comprises a body 152, preferably cylindrical, having an upper end 154 and a lower end 156; at least one partial through-bore 146 beginning at the outer surface of the upper end 154 of the body and forming an inner, hollow core or chamber 158; at least one, spherical or ball lens 70 removably and frictionally mounted on said upper end 154 and sealably fixed within said through-bore 158, such that said spherical or ball lens 70 completely fills and seals the upper end 154 of the hollow core or chamber 156 and partially forms the upper surface of the upper end 154 of the probe; an incident light source 12 and at least one optical detecting fiber 142 supported and enclosed within said inner, centrally enclosed hollow core or chamber 158 of the probe; and a photodetector 150 connected to said one optical detecting fiber 142.

It is important that the probe be made, at least partially and preferable at its upper end 154 of a material that permits an uncompromisable seal for all of the probe's components, without the use of additional seals, gaskets, windows or other sealing compounds (e.g. epoxy, silicone or similar) and which does away with the need to find a broad range of chemically compatible, broad range temperature, insensitive seals, gaskets or sealing compounds. Furthermore, it has to be compatible with both the solvents in which the specimen particles are suspended, as well as be compatible with the specimen particles themselves. Finally, it must not break down, either physically or chemically, when coming in contact with the solvents and the specimen particles suspended therein, in a wide range of temperatures. One material that has the ability to provide all of the foregoing is Polyetheretherketone (PEEK).

In the preferred embodiment, the probe is at least partially made of PEEK. Not only is it compatible with a very wide range of solvent liquids and sample particles, but is also neutral in that it does not leach contaminants into the sample of liquid-suspended particles; even when it is exposed to temperatures ranging from 0 degrees C. to 160 degrees C. Use of PEEK in the probe allows for a secure seal between the spherical or ball lens and the upper end of the probe, without the use of additional seals, gaskets, windows or other sealing compounds (e.g. epoxy, silicone or similar).

The process of utilizing the probe, having the spherical or ball lens optical system, comprises the following steps: communicatingly connecting the at least one optical detecting fiber to said photodetector; supplying power and using the incident light source within the inner chamber of the probe to generate a focused beam of light; focusing the light beam on the spherical or ball lens, frictionally but removably fixed at said lower end of the probe sealing the through-bore, such that the beam penetrates and enters the spherical or ball lens at a zero degree angle relative to the path of said incident light beam; immersing the probe into a sample of liquid suspended particles needing to be measured and characterized; focusing the beam of light through its corresponding spherical or ball lens onto the sample of liquid suspended particles. The molecules or particles within the laser beam's path at the focal point of the spherical or ball lens, and adjacent thereto scatter light. The spherical or ball lens then collimates the scattered light and focuses it back through said spherical or ball lens, onto the detecting fiber, which in turn is sends it to the photodetector which in turn converts to provide data that generates information regarding the physical characteristics and chemical properties of the liquid-suspended particles in the specimen, in which the probe was immersed.

As a result of the components of the inventive optical spherical or ball lens light scattering apparatus and its various embodiments disclosed herein above and the way they cooperatingly function, it is clear that they achieve all of the objectives set forth herein above including: (i) minimizing, if not totally eliminating, those errors in the results of light scattering technology applications, that arise from the background effects created or contributed by the sample cell; (ii) minimizing, if not totally eliminating, those errors in the results of light scattering technology applications, that arise from the background effects created or contributed by the suspension fluid; (iii) minimizing, if not totally eliminating, any and all refractive index effects on the light beam generated by the incident light source, as the light beam travels and transitions from one medium and into another; (iv) generating a light beam that will, more likely than not, enter the suspension fluid at a zero degree angle relative to the incident path or axis of said light beam; (v) minimizing, if not completely eliminating, the light scattering masking of particles' light scattering results, effectuated by the impurities found in the sample cell and the impurities found in the suspension fluid; (vi) minimizing, if not completely eliminating, the light scattering masking of particles' light scattering results, effectuated by the reflection or bouncing back into the suspension fluid, of light not successfully exiting the sample cell; and (vii) minimizing, if not completely eliminating, the light scattering masking of particles' light scattering results, effectuated by air bubbles trapped in the sample cell or in the suspension fluid.

While particular embodiments of the invention have been illustrated and described in detail herein, they are provided by way of illustration only and should not be construed to limit the invention. Since certain changes may be made without departing from the scope of the present invention, it is intended that all matter contained in the above description, or shown in the accompanying drawings be interpreted as illustrative and not in a literal sense. Practitioners of the art will realize that the sequence of steps and the embodiments depicted in the figures can be altered without departing from the scope of the present invention and that the illustrations contained herein are singular examples of a multitude of possible depictions of the present invention.

We claim:

1. An apparatus for light scattering analysis of particles dispersed in a suspension fluid comprising at least one ball lens in direct contact with the suspension fluid.

2. The apparatus of claim 1, wherein said one ball lens is interposed between an incident light source and a photodetector.

3. The apparatus of claim 2, wherein said incident light source comprises a laser.

4. The apparatus of claim 2, wherein said photodetector is selected from the group of phtotodetectors consisting of photomultipliers, avalanche photodiodes, and charge-coupled devices.

5. The apparatus of claim 3, wherein said photodetector is selected from the group of phtotodetectors consisting of photomultipliers and avalanche photodiodes.

6. A method for light scattering analysis of particles dispersed in a suspension fluid comprising the step of focusing an incident beam of energy through a ball lens contacting said suspension fluid and into said suspension fluid.

7. A method for light scattering analysis of particles dispersed in a suspension fluid comprising the steps of: (i) using an incident light source to generate a beam of energy having a certain wavelength and frequency; (ii) focusing said beam of energy through a ball lens; (iii) placing a specimen of particles, dispersed in a suspension fluid, at the focal point of said ball lens so that said ball lens is in direct contact with the suspension fluid and the focused beam of energy hits the suspended particles at exactly the focal point of the ball lens to cause the suspended particles to scatter the beam of energy; and (iv) directing that scattered light produced by the suspended particles through a ball lens onto a photodetector.

8. A sample cell for use in light scattering analysis of particles dispersed in a suspension fluid comprising:
a cell block having an upper end and a lower end, and an inner, centrally enclosed chamber;
at least three through-bores placed on the same horizontal plane, within said cell block,
one through-bore being an incident through-bore, another being an exit through-bore, and the third one being a measuring through-bore,
said incident through-bore and said exit through-bore being juxtaposed end to end, but spaced apart the full width of the inner, centrally enclosed chamber, so that their terminating openings into said inner, centrally enclosed chamber, are positioned exactly across from and are co-axial to each other, at opposite walls of the inner, centrally enclosed chamber, whereby when a laser beam is focused through said incident through-bore, it enters into said inner, centrally enclosed chamber, and emerges out said exit through-bore, and
Said measuring through-bore is interposed between said end to end, juxtaposed incident through-bore and exit through-bore, such that said measuring through-bore's longitudinal axis is perpendicular to the co-aligned longitudinal axes of the two juxtaposed through-bores, and its terminating opening into said inner, centrally enclosed chamber is approximately equidistant from the terminating openings of the juxtaposed through-bores;
at least three ball lenses, removably and frictionally fixed within each of said through-bores such that they partially form and seal the wall of the inner, centrally enclosed chamber; and
means for introducing into said inner, centrally enclosed chamber a specimen of said particles dispersed in said suspension fluid, as well as means for removing said specimen therefrom.

9. The sample cell of claim 8, wherein said ball lenses are selected from the group of ball lenses consisting of ruby ball lenses, sapphire ball lenses and glass lenses.

10. The sample cell of claim 8, wherein said ball lenses have a diameter range from 0.5 mm to 10 mm.

11. The sample cell of claim 8, wherein said cell block consists of PEEK.

12. The sample cell of claim 9, wherein said cell block consists of PEEK.

13. The sample cell of claim 10, wherein said cell block consists of PEEK.

14. A method for light scattering analysis of particles dispersed in a suspension fluid comprising the steps of:
equipping a sample cell with a cell block having an inner, centrally enclosed chamber, at least three through-bores placed on the same horizontal plane, within said cell block, one through-bore being an incident through-bore, another being an exit through-bore, and the third one being a measuring through-bore, said incident through-bore and said exit through-bore being juxtaposed end to end, but spaced apart the full width of the inner, centrally enclosed chamber, so that their terminating openings into said inner, centrally enclosed chamber, are positioned exactly across from and are co-axial to each other, at opposite walls of the inner, centrally enclosed chamber, whereby when a laser beam is focused through said incident through-bore, it enters into said inner, centrally enclosed chamber, and emerges out said exit through-bore, and said measuring through-bore is interposed between said end to end, juxtaposed incident through-bore and exit through-bore, such that said measuring through-bore's longitudinal axis is perpendicular to the co-aligned longitudinal axes of the two juxtaposed through-bores, and its terminating opening into said inner, centrally enclosed chamber is approximately equidistant from the terminating openings of the juxtaposed through-bores; at least three ball lenses, removably and frictionally fixed within each of said through-bores such that they partially form and seal the wall of the inner, centrally enclosed chamber and come in contact with said suspension fluid, and means for introducing into and removing from said an inner, centrally enclosed chamber a sample a specimen of particles dispersed in said suspension fluid;
supplying power and generating a focused laser beam;
focusing the laser beam both through the incident through-bore and its corresponding ball lens;
filling said inner, centrally enclosed, chamber, either manually or via a pump system, with a specimen of fluid-suspended particles needing to be measured and characterized, such that said incident ball lens, said exit ball lens and said measuring ball lens are in direct contact with said specimen;
focusing the laser beam through the incident through-bore and through its corresponding ball lens onto the specimen of fluid-suspended particles and out the exiting through-bore and its corresponding spherical or ball lens adjacent to the inner, centrally enclosed, hollow micro-volume chamber to allow the particles within the laser beam's path to scatter the light from the laser beam; and
collimating the scattered light for transmittal to a photodetector.

15. A probe for use in light scattering analysis of particles dispersed in a suspension fluid comprising a ball lens that is in direct contact with said suspension fluid.
